(19) United States
(12) Patent Application Publication
(10) Pub. No.: US 2003/0035527 A1
(43) Pub. Date: Feb. 20, 2003

(54) Conference call tunneling method and apparatus

(76) Inventor: Charles Baker, Apex, NC (US)

Correspondence Address: JAMES Y SZE, PILLSBURY WINTHROP LLP, INTELLECTUAL PROPERTY GROUP, 11682 EI CAMINO REAL, SUITE 200, SAN DIEGO, CA, 93102, US

(21) Appl. No.: 09/930,436

(22) Filed: Aug. 14, 2001

(51) Int. Cl. H04M 3/42

(52) U.S. Cl. 379/207.01

(57) ABSTRACT

A process, apparatus and system to support call tunneling, a private conversation between a subset of conference call participants, conducted over any network, the private conversation excluding other conference call participants. When call tunneling is activated, participants in the call tunnel route their audio/video/multimedia data selectively. The selectively routed data is sent only to other participants in the call tunnel, thus creating a private conversation within the conference call. The resulting private conversation may be identical in format type (audio, video, or multimedia) as the simultaneously occurring conference call.

### BACKGROUND

1. Field of the Invention

Aspects of the present invention relate in general to packet-based telephony, and an apparatus, system and method to initiate a private conversation between some conference call participants, while excluding other conference call participants.

2. Description of the Related Art

In a conventional audio conference call, multiple parties are remotely coupled via the telephone network. For example, hypothetical parties A, B, and C respectively located in, Durham, San Jose, and San Diego in participate in a conference call together.

As shown in the system 20 of FIG. 1A, in one form of a conference call, voice data is transmitted between each conference call phone 10A-C on separate connections. In such a conference call, voice data is transmitted in each direction, as indicated by the directional arrows. Alternatively, as shown in FIG. 1B, conference call participants 10B-C may call one phone 110A, that routes voice data in each direction. Lastly, in as shown in FIG. 1C, all conference call participants 10A-C call a conventional conference call server 130 which routes voice data to each participant.

During the conference call, parties A and B may want to have a private conversation between them, without C, while still remaining within the conference call. Conventionally, parties A and B would have to use another, different, means of communication, such as facsimile, electronic-mail, instant messaging, or other form of non-audio communication to initiate and maintain a private conversation. Not only would the non-audio communication be more difficult than talking, but the private conversation would also require a separate phone line, or computer network to facilitate the communication, wasting precious communication resources.

### BRIEF DESCRIPTION OF THE DRAWINGS

FIGS. 1A-1C illustrate a system that facilitates a standard telephone conference call.

FIG. 2 is a diagram of a system embodiment that facilitates “call tunneling,” a private conversation between some conference call participants, while excluding other conference call participants.

FIG. 3 depicts an apparatus embodiment that facilitates call tunneling.

FIG. 4 is an act diagram of an apparatus embodiment that facilitates call tunneling.

FIG. 5 is an illustration of a user interface embodiment that facilitates call tunneling.

FIGS. 6A-6F illustrate systems facilitating call tunneling.

FIGS. 7A-7C are flowcharts of a method that facilitates call tunneling.

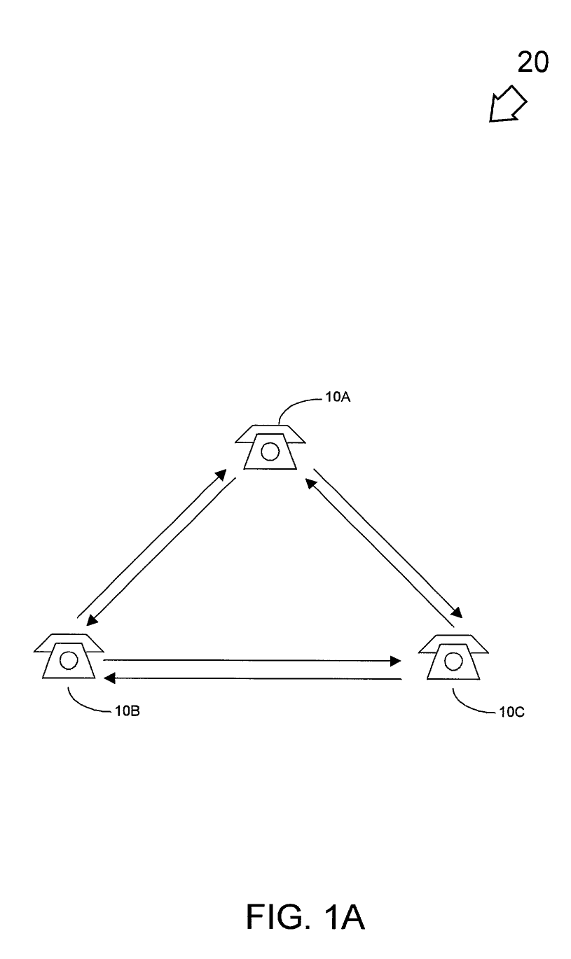

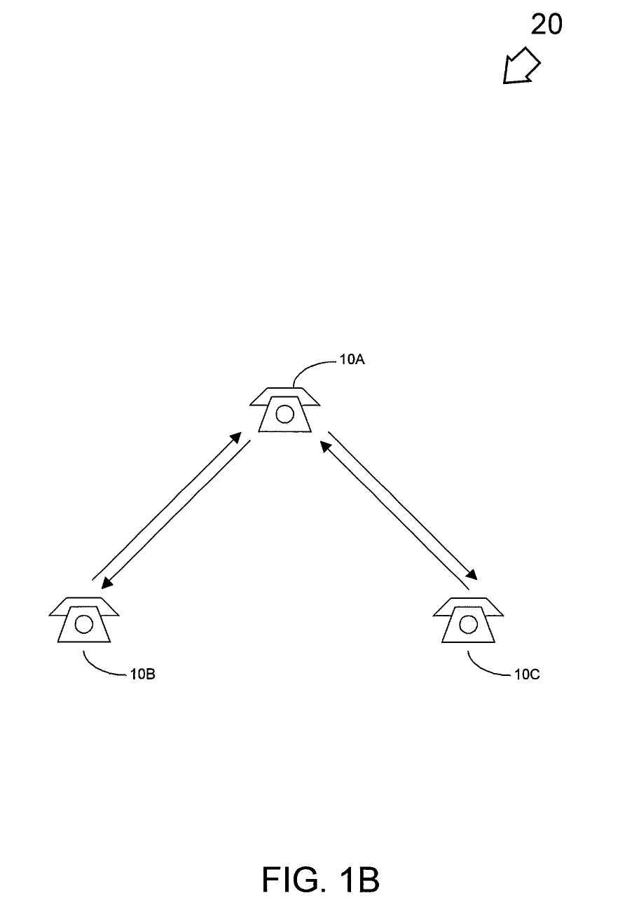

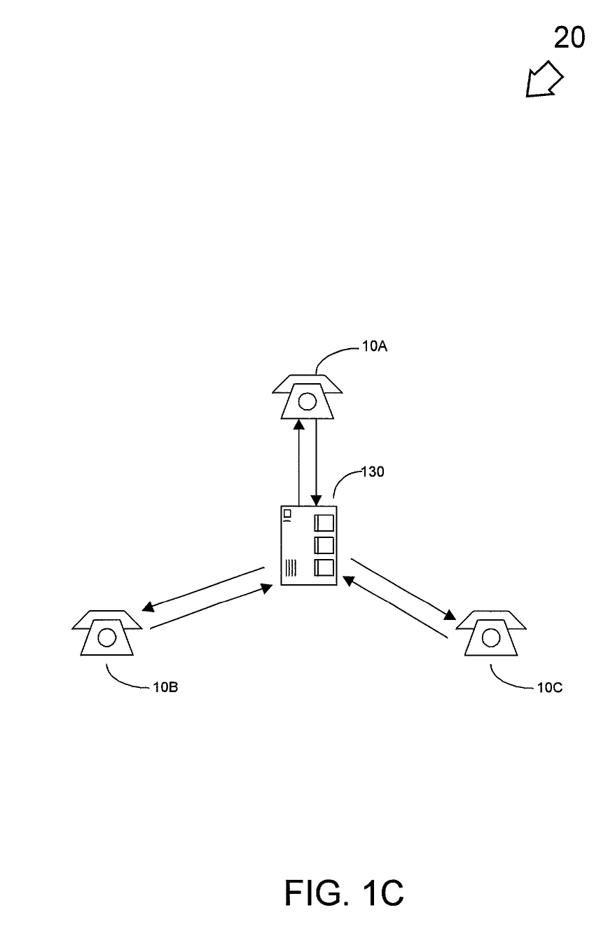

### DETAILED DESCRIPTION

What is needed is an easy-to-use apparatus and method capable of initiating and facilitating a private conversation between a subset of conference call participants, or “call tunneling.”

Aspects of the present invention include method, apparatus, user-interface, and system for facilitating call tunneling. As will be described below, call tunneling may be performed over any communications network as is known in the art. In some embodiments, call tunneling may be performed on an Internet Access Device (IAD) in conjunction with an Intelligent Network (IN) or Next Generation Network (NGN). In other embodiments, the call tunneling may be performed through the selective routing of audio signal or voice packets on a packet switched network.

The term “call tunneling,” as used herein, may refer to any private conversation between a subset of conference call participants, conducted over any network, the private conversation excluding other conference call participants. When call tunneling is activated, participants in the call tunnel route their audio/video/multimedia data selectively. The selectively routed data is sent only to other participants in the call tunnel, thus creating a private conversation within the conference call. The resulting private conversation may be identical in format type (audio, video, or multimedia) as the simultaneously occurring conference call. Those known in the art will understand that the following embodiment methods, systems, and apparatus may be equally applied to audio, video, or multimedia conference calls. Moreover, depending upon the type of call tunneling implemented, the call tunneling initiator may decide to selectively route their audio, video, or multimedia data, or any combination thereof.

Call tunneling may be facilitated through a number of differing embodiments that selectively forward communications signals to parties participating in the private conversation. In one embodiment, the call tunneling may be performed when a conference call server 135 performs the filtering acts. In other alternate embodiments, the filtering may be performed by an internet access device or telephone incorporating an internet access device performs the filtering.

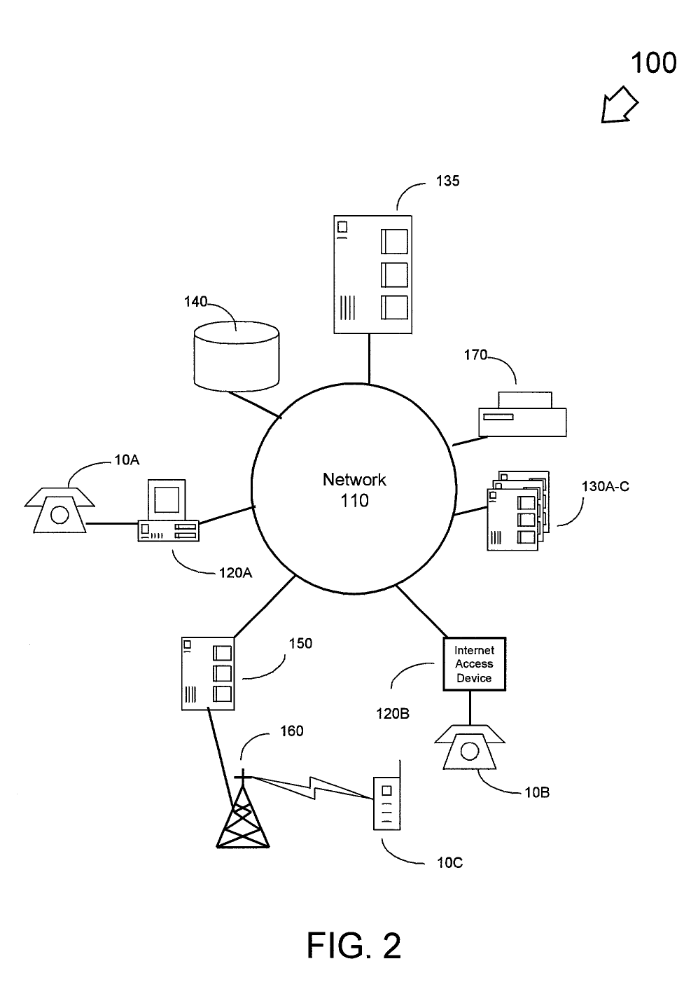

FIG. 2 is a simplified functional act diagram depicting system 100, constructed and operative in accordance with an embodiment of the present invention. System 100 is configured to facilitate a private conversation between a subset of parties participating in a conference call.

In system 100, internet access devices 120 are coupled via a communications network 110. Users may communicate to other users via internet access devices 120, telephones 10A-B coupled to internet access devices 120A-B, or wireless phones 10C. It is understood by those known in the art, that either such device may be coupled via a single or multiple number of networks 110.

In some embodiments, internet access device 120 may be a personal computer, personal digital assistant (PDA), wireless phone, or other such network-computing device.

The network 110 may also include other networkable devices known in the art, such as other internet access devices 120, storage media 140, conference call server 135, telephone server 150, servers 130A-C, and wireless telephone base station 160. It is well understood in the art, that any number or variety of computer networkable devices or components may be coupled to the network 110 without inventive faculty, such as printers 170. Examples of other devices include, but are not limited to, servers, computers, workstations, terminals, input devices, output devices, printers, plotters, routers, bridges, cameras, sensors, or any other such device known in the art.

Internet access device 120 may be any apparatus known in the art that is able to communicate on the network 110.

Network 110 may be any communication network known in the art, including a conventional telephone network, the Internet, a local-area-network (LAN), a wide-area-network (WAN), or any system that links a conference call server 135 to a telephone 10. Further, network 110 may be of configured in accordance with any topology known in the art, including star, ring, bus, or any combination thereof.

Conference call server 135 is coupled to a telephone network 110 that supports the receipt and transmission of digital packets. Telephone network server 150 may be configured to allow different networks to communicate, as well as communicate with a public switch telephone network (PSTN), plain old telephone service (POTS), Integrated Services Digital Network (ISDN), SIP (Session Initiation Protocol), International Telecommunications Union (ITU) H.323, Real Time Transport Protocol (RTTP), any Voice Over Internet Protocol standard, or any other telephone network. In some system embodiments, a conference call server 135 may obviate the use of internet access devices 120 by conference call participants.

Furthermore, as shown in FIG. 2, telephone network server 150 may be coupled to wireless base station 160, which allows communication to wireless phone 10C.

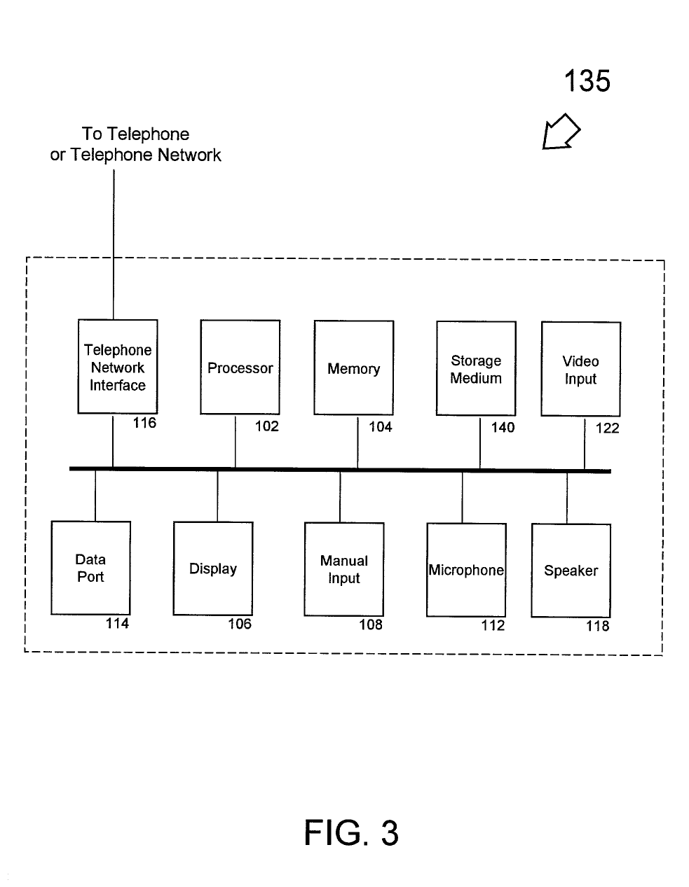

Embodiments will now be disclosed with reference to a functional act diagram of an exemplary conference call server 135 of FIG. 3, constructed and operative in accordance with an embodiment of the present invention. Conference call server 135 runs a multi-tasking operating system and includes at least one processor or central processing unit (CPU) 102. Processor 102 may be any microprocessor or micro-controller as is known in the art.

The software for programming the processor 102 may be found at a computer-readable storage medium 140 or, alternatively, from another location across network 110. Processor 102 is coupled to computer memory 104. Conference call server 135 may be controlled by an operating system (OS) that is executed within computer memory 104.

Processor 102 communicates with a plurality of peripheral equipment, including telephone network interface 116. Additional peripheral equipment may include a display 106, manual input device 108, storage medium 140, microphone 112, video input 122, and data port 114.

Display 106 may be a visual display such as a cathode ray tube (CRT) monitor, a liquid crystal display (LCD) screen, touch-sensitive screen, or other monitors as are known in the art for visually displaying images and text to a user.

Manual input device 108 may be a conventional keyboard, keypad, mouse, trackball, or other input device as is known in the art for the manual input of data.

Storage medium 140 may be a conventional read/write memory such as a magnetic disk drive, floppy disk drive, compact-disk read-only-memory (CD-ROM) drive, transistor-based memory or other computer-readable memory device as is known in the art for storing and retrieving data. Significantly, storage medium 140 may be remotely located from processor 102, and be coupled to processor 102 via a network 110 such as a local area network (LAN), a wide area network (WAN), or the Internet.

Microphone 112 may be any suitable microphone as is known in the art for providing audio signals to processor 102. In addition, a speaker 118 may be attached for reproducing audio signals from processor 102. Video input 122 may be a digital or analog video camera device to record still or moving images. In some embodiments, video input 122 may be a scanner device. It is understood that microphone 112, speaker 118, and video input 122 may include appropriate digital-to-analog and analog-to-digital conversion circuitry as appropriate.

Data port 114 may be any data port as is known in the art for interfacing with an external accessory using a data protocol such as RS-232, Universal Serial Bus (USB), or Institute of Electrical and Electronics Engineers (IEEE) Standard No. 1394 (‘Firewire’). In some embodiments, data port 114 may be any interface as known in the art for communicating or transferring files across a computer network, examples of such networks include Transmission Control Protocol/Internet Protocol (TCP/IP), Ethernet, Fiber Distributed Data Interface (FDDI), token bus, or token ring networks. In addition, on some systems, data port 114 may consist of a modem coupled to telephone network interface 116. Similarly, telephone network interface 116 provides connectivity to conference call server 135 to communicate with a telephone network 150. Thus, the telephone network interface 116 allows the conference call server 135 to communicate and process input and output from a telephone line.

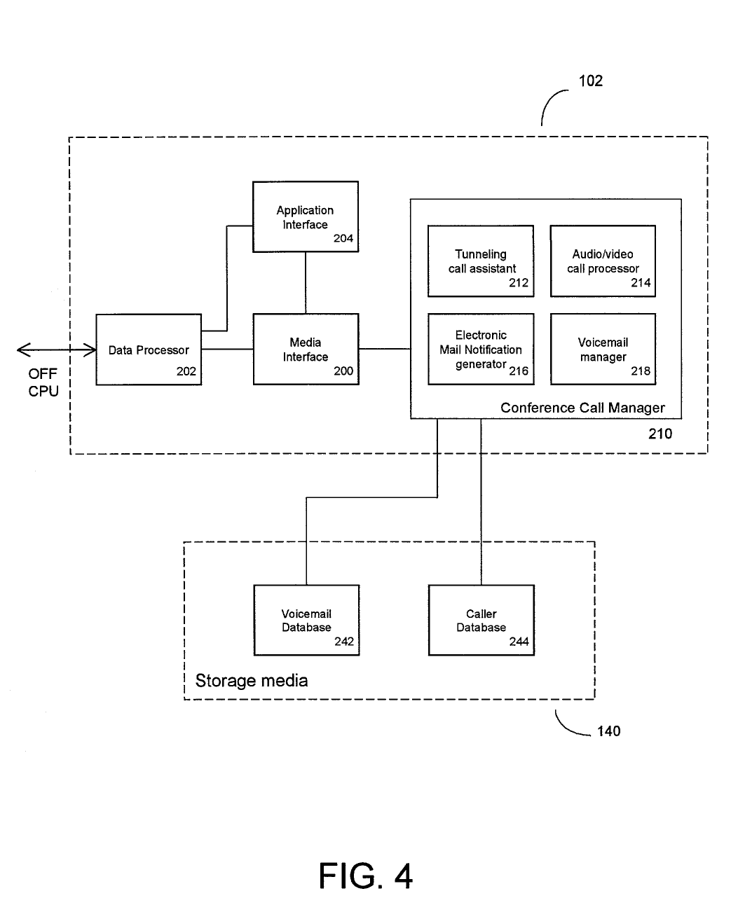

FIG. 4 is an expanded functional act diagram of CPU 102 and storage medium 140. It is well understood by those in the art, that the functional elements of FIG. 4 may be implemented in hardware, firmware, or as software instructions and data encoded on a computer-readable storage medium 140. As shown in FIG. 4, central processing unit 102 comprises a data processor 202, an application interface 204, a media interface 200, and a conference call manager 210. These structures may be implemented as hardware, firmware, or software encoded on a computer readable medium, such as storage media 140. In addition, as shown in FIG. 4, storage media 140 may also contain a voicemail database 242, and a caller database 244.

Data processor 202 interfaces with display 106, manual input device 108, storage medium 140, microphone 112, data port 114, video input 122, memory 104, speakers 118, and telephone network interface 116. The data processor 202 enables processor 102 to locate data on, read data from, and write data to, these components.

Application interface 204 enables processor 102 to take some action with respect to a separate software application or entity. For example, application interface 204 may take the form of a windowing user interface, as is commonly known in the art.

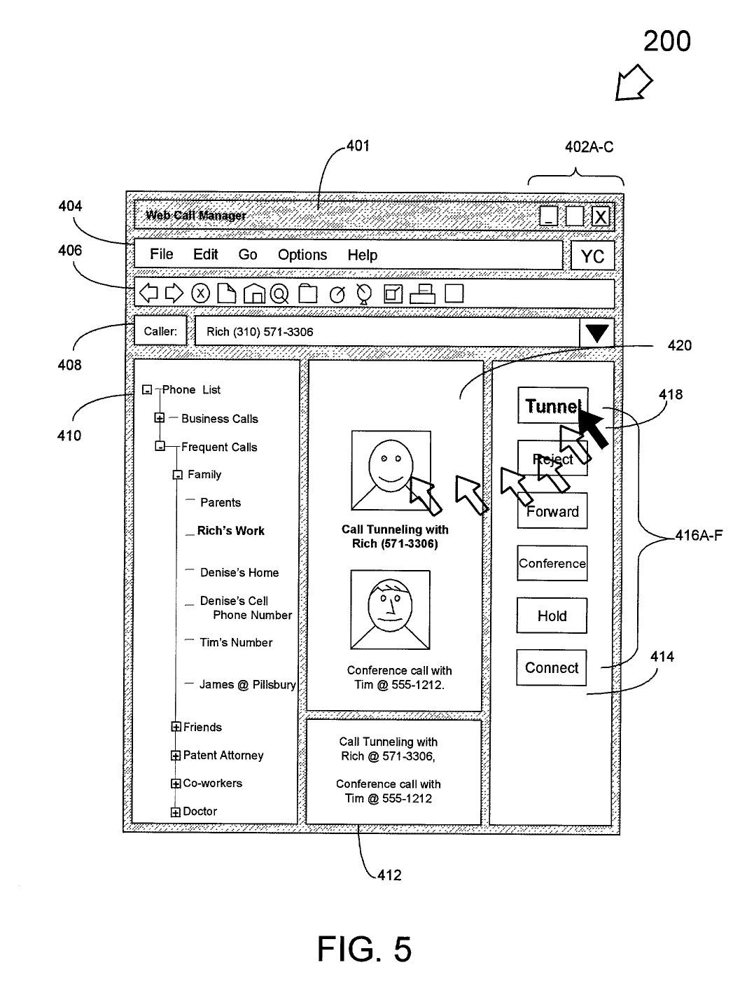

Media interface 200 is a web-enabled call interface. In some embodiments, the media interface 200 may be stand-alone program, or a web-browser window. An example of such a media interface window is shown in FIG. 5. Media interface window 200 comprises title bar 401, window control buttons 402A-C, menu bar 404, button bar 406, address bar 408, phone-list frame 410, main frame 420, status frame 412, and control frame 414.

In some embodiments, main frame 420 displays a picture of the current caller retrieved from a caller database 244. In such embodiments, using the mouse pointer 418, users may either click control buttons 416A-F, or “drag-and-drop” callers listed in the phone list frame 410, or pictures of the caller in the main frame 420 to control buttons 416A-E in the control frame 414. Media interface 200 then selects the appropriate structure to execute the functionality specified by the control button 416.

Returning to FIG. 4, conference call manager 210 may further comprise a tunneling call assistant 212, an audio/video call processor 214, an electronic mail notification generator 216, and a voicemail manager 218.

Tunneling call assistant 212 allows media interface to 200 communicate with multiple parties in a conference call. In addition, tunneling call assistant 212 determines which parties receive communication packets, and the communication packets received. For example, suppose party A, B, and C are participating in a conference call. If party A and B begin an audio call tunneling session, audio packets that originate from party A and B's phones 10A-B are no longer forwarded to party C's phone 10C.

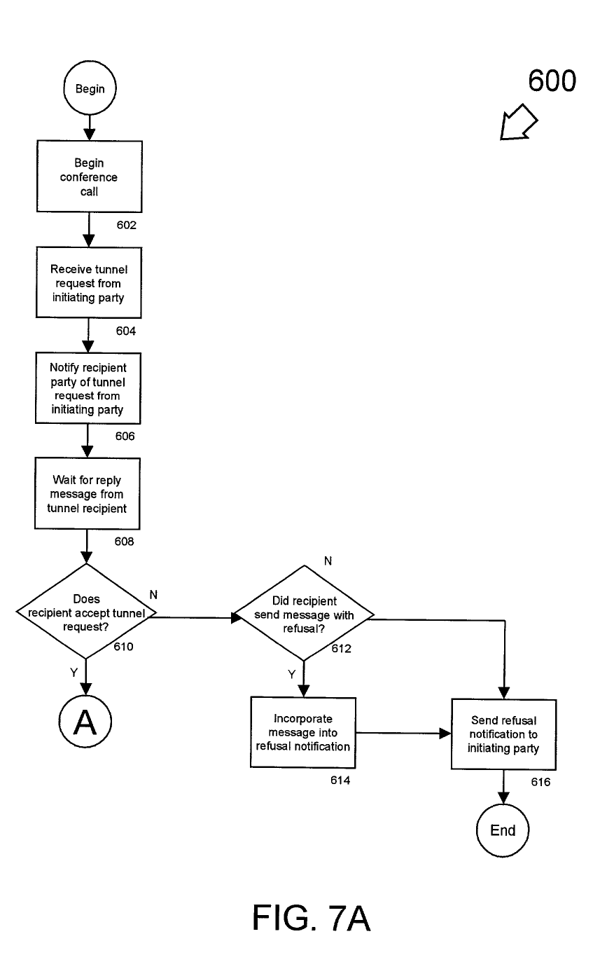

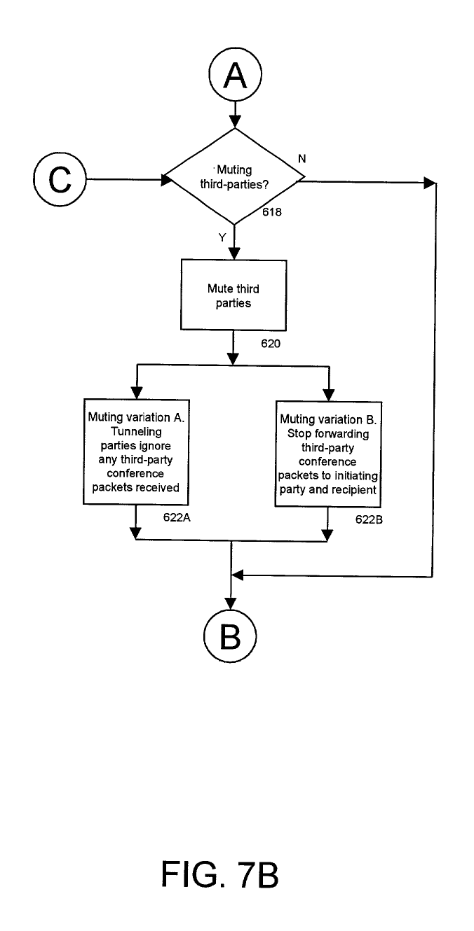

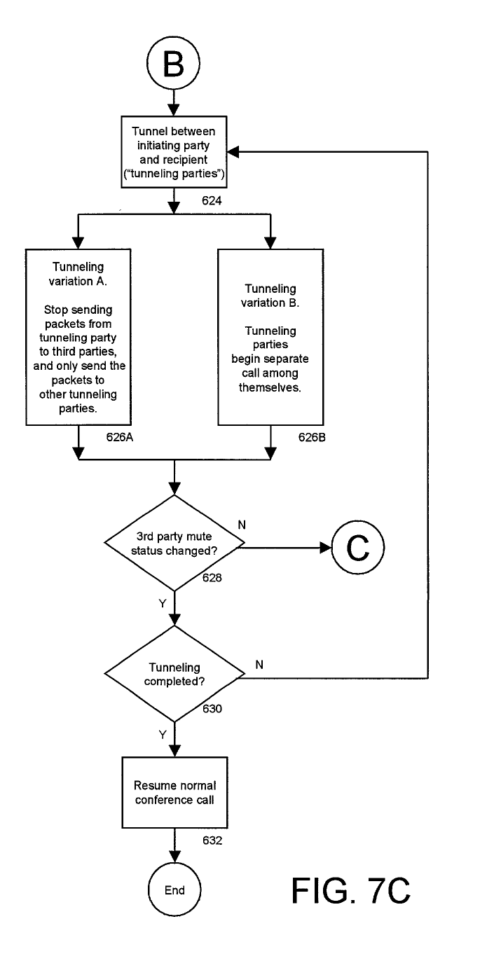

Audio/video call processor 214 allows media interface 200 to utilize video input 122, microphone 112, speaker 118 and display 106 for audio or multimedia-video-based calls. Electronic mail notification generator 216 allows media interface to communicate through text-based messaging systems, such as electronic mail or, in some embodiments, instant-messaging programs. Voicemail manager 218 communicates with media interface 200 and stores messages in a voicemail database 242. These components of conference call manager 210 interact with a voicemail database 242, and a known caller database 244, and may best be understood with respect to the flowcharts of FIGS. 7A-7C, as described below.

Embodiments will now be disclosed using examples depicting three conference call participants, parties A, B, and C, using phones 10A, 10B, and 10C, respectively. It is understood that these examples, which are used for illustrative purposes only, in no way limit the number of participants in a conference call or call tunnel. It is further understood that there may be any plurality of conference callers or call tunnel participants. It is also understood that in some instances call tunneling may be initiated with parties not participating in the conference call.

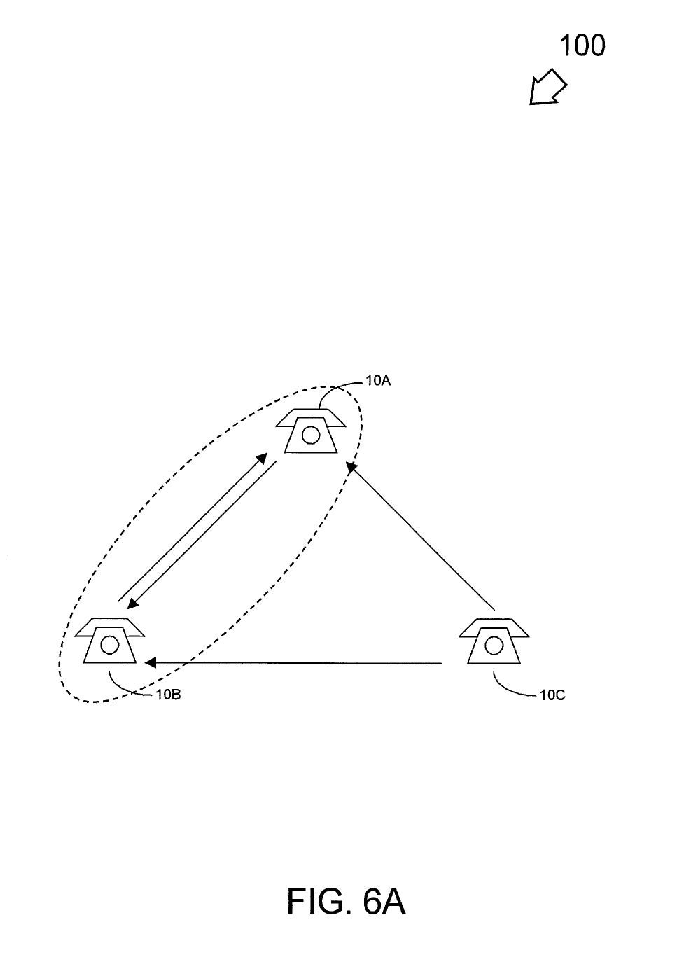

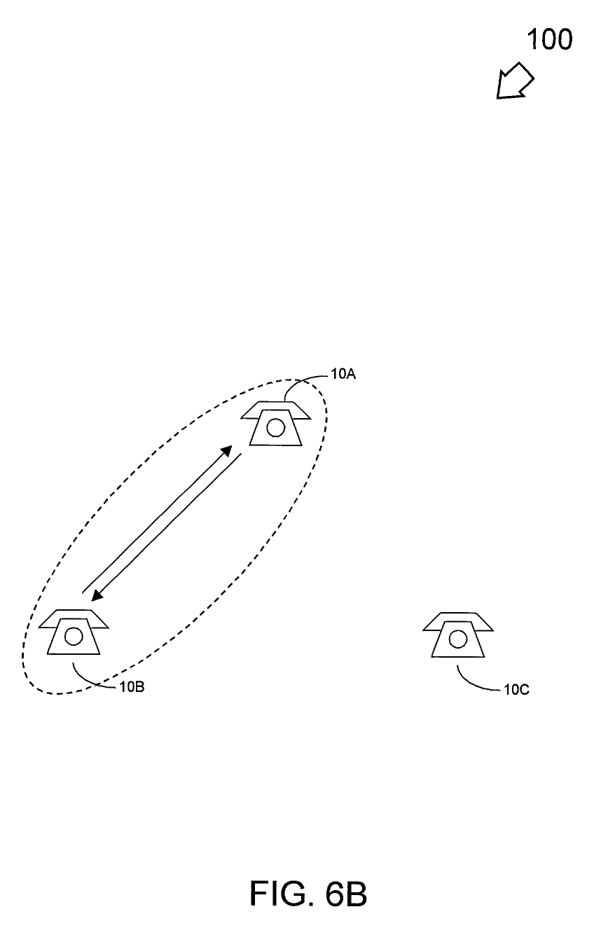

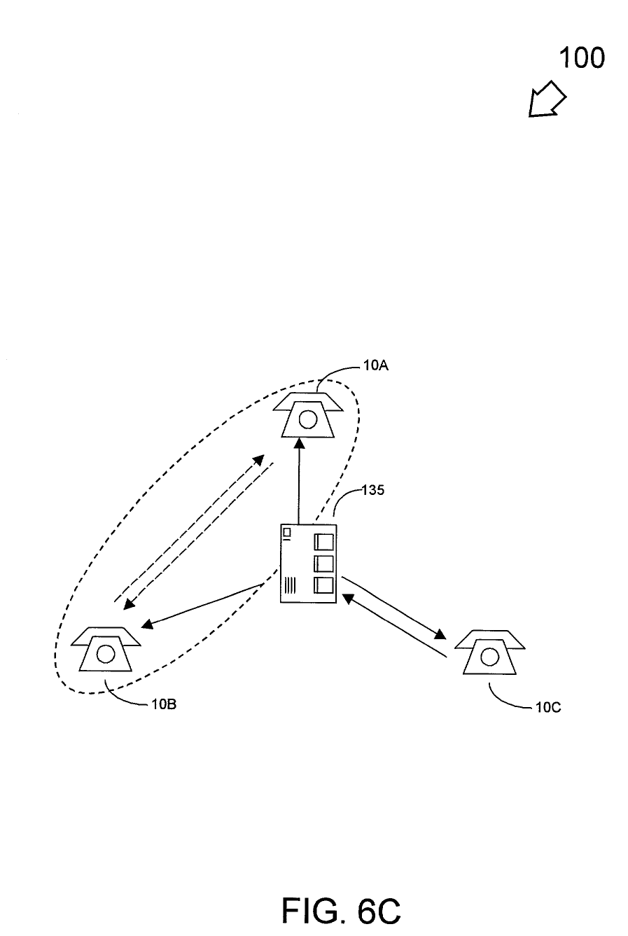

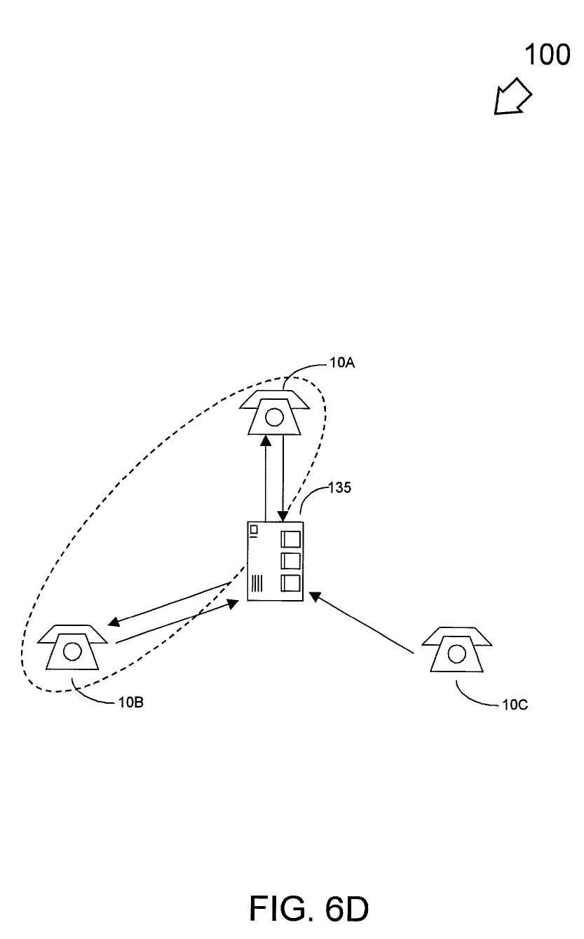

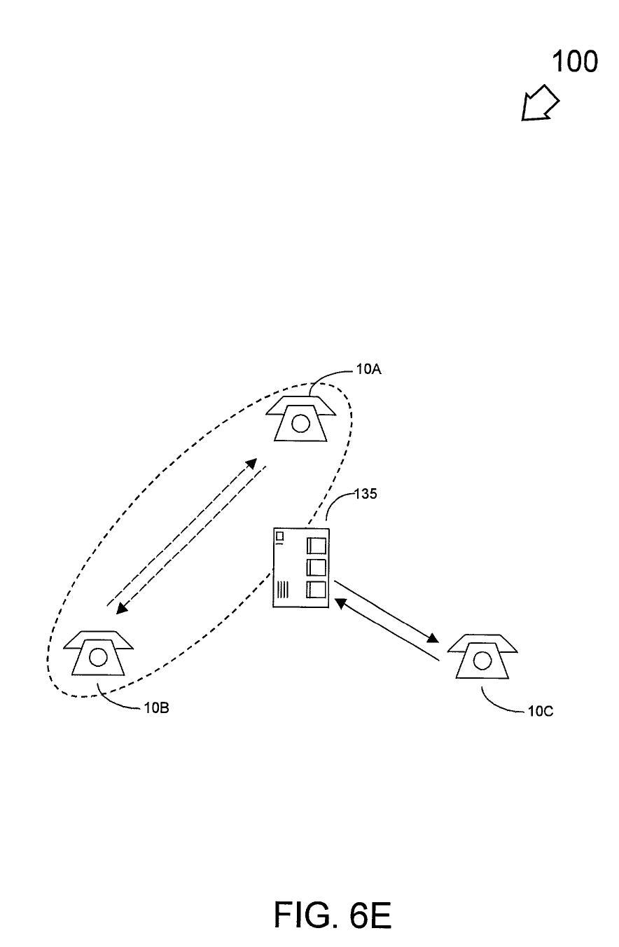

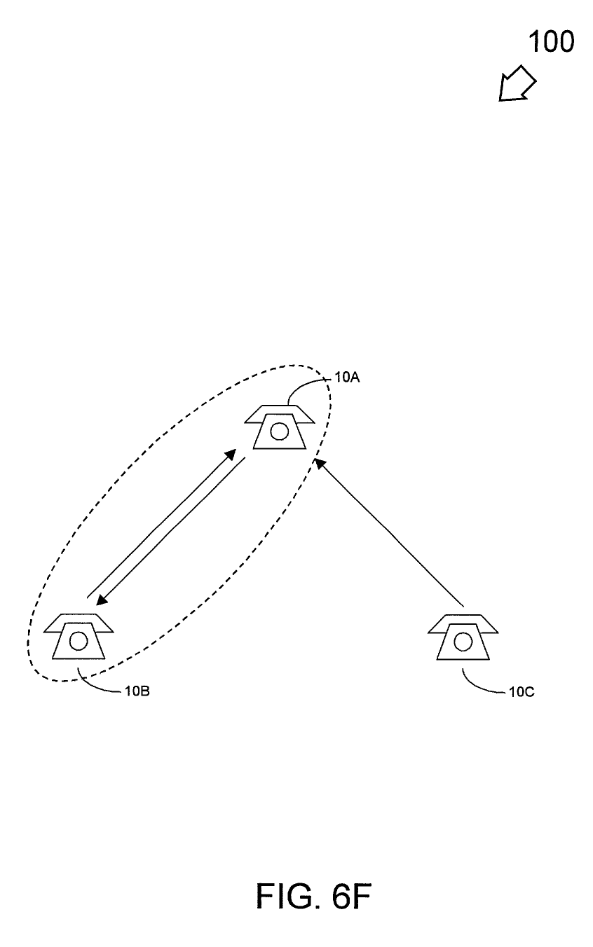

FIGS. 6A-6F depict systems to facilitate a call tunneling session during a conference call, constructed and operative in accordance with an embodiment of the present invention. Each figure illustrates a different multi-way conference call embodiment in which call tunneling is performed between the parties A and B, depicted as circled phones 10A and 10B. Third party phone 10C remains within the conference call (with any remaining non-tunneling third parties), but does not participate in the call tunneling session.

FIG. 6A illustrates an embodiment in which the call tunnel is created when call tunneling participants 10A and 10B stop forwarding audio/video/communication packets to the third parties phones 10C. Additionally, call tunneling participants 10A and 10B may continue listening to the conference call, or optionally mute the call by ignoring the packets received from third parties.

FIG. 6B illustrates an embodiment in which the call tunnel is created when call tunneling participants 10A and 10B stop forwarding audio/video/communication packets to the third parties phones 10C and the conference call is muted because no packets are received from third parties.

FIG. 6C illustrates an embodiment in which the call tunnel is created when call tunneling participants 10A and 10B stop forwarding audio/video/communication packets to the conference call manager 135, and a separate conference call is created between the call tunneling parties. Because the packets are no longer sent to the conference call manager 135, third parties cannot hear the contents of the call tunneling session.

FIG. 6D illustrates an embodiment in which the call tunnel is created when call tunneling participants 10A and 10B continue forwarding audio/video/communication packets to the conference call manager 135. The call tunneling session is created through the intelligent filtering of packets, related to the call tunneling session, from being forwarded to third parties. Consequently, third parties cannot hear the contents of the call tunneling session, but remain in the conference call.

FIG. 6E illustrates an embodiment in which the call tunnel is created when call tunneling participants 10A and 10B stop forwarding any audio/video/communication packets to the conference call manager 135, and a separate conference call is created for the call tunneling session.

FIG. 6F illustrates an embodiment in which the call tunnel is created between call tunneling participants 10A and 10B. The call tunneling session is created through the intelligent filtering of packets by 10A, related to the call tunneling session, from being forwarded to third parties 10C. Consequently, third parties cannot hear the contents of the call tunneling session, but remain in the conference call.

FIGS. 7A-7C flowcharts a process 600 to facilitate a call tunneling session during a conference call, constructed and operative in accordance with an embodiment of the present invention.

At act 602, a conference call is created between parties A, B, and C.

At any point during the conference call, party A may request a call tunneling session with another party, party B, participating in the conference call, act 604. In some embodiments using media interface window 200, the tunnel request may be initiated by dragging or highlighting an icon or data entry (representing the party B), and clicking on a “tunnel” menu option or control button 416. In phone embodiments, the tunnel request may be initiated by selecting a phone menu option or pressing a key combination on the phone 10.

The conference call manager 210 notifies the tunnel request recipient party, party B, of the tunnel request, act 606, and then waits for a reply from party B, act 608.

When the reply message is received, the tunneling call assistant 212 determines whether the tunnel request recipient party agrees to the call tunneling sessions, act 610. If the tunneling session is refused, flow continues at act 612. If the tunneling is accepted, process 600 continues at act 618.

At act 612, the conference call manager 210 determines whether the recipient sent a text or multimedia message along with the refusal. If no message was sent along with the refusal, a refusal notification is sent to the initiating party, party A, at block 616. If a message was sent along with the refusal, the message is incorporated into the refusal notification 614. The refusal notification is then sent to the initiating party, party A, via the media interface 200, or in some embodiments, via electronic mail through the electronic mail notification generator 216, act 616. Process 600 would then end, if the tunneling session was refused.

Continuing on FIG. 7B, before process 600 initiates the call tunneling, it determines how third parties, those conference-call parties not participating in the call tunneling session (e.g. party C), will be treated.

At act 618, a determination is made on whether third parties are muted. When third parties 10C are muted at act 620, their conference call packets are either ignored or discarded by the call tunneling participants 10A-B, act 622A. Embodiments that ignore conference call packets from third parties 10C are shown in FIGS. 6A, 6C, 6D, and 6F. Alternatively, in some embodiments, the third parties 10C stop forwarding the audio or other conference packets to the call tunneling participants 10A-B, act 622B; these embodiments are shown in FIGS. 6B, and 6E.

Process 600 continues at FIG. 7C, where the call tunneling is performed.

At act 624, the call tunneling is initiated by the initiating party 10A and the recipient 10B.

In some embodiments, the private call tunnel is created when tunneling parties are no longer sending packets to third parties, act 626A. In such an embodiment, the conference call manager 135 only routes call packets between the tunneling parties 10A-B, and does not send the packets to the third parties 10C participating in the conference call. For example, in an audio conference call, the voice packets from tunneling party 10A are routed to party 10B, and vice versa, but no packets are routed to 10C. Such an embodiment is shown in FIGS. 6C and 6D. It is understood that this technique may be equally applicable in embodiments without a conference call manager 135, as shown in FIGS. 6A and 6B.

Alternatively, in other embodiments, the call tunnel may be created by creating a separate phone call to carry the voice packet between the tunneling parties, as shown in FIGS. 6C and 6D.

It is understood that variations and combinations thereof may apparent to one skilled in the art.

At act 628, process 600 determines whether the third party mute status has changed. In some embodiments, the call tunneling parties may change the third party mute status through the media interface 200. For example, by pressing a physical button on a phone embodiment or changing the status through clicking a control button 416 or selecting a menu option off the menu bar 404. If the third party mute status has changed, the process flow returns to act 616. Otherwise, the process flow continues at act 630.

At decision act 630, the process 600 determines whether the call tunneling has been completed. The call tunneling may end through an interaction with media interface 200, such as pressing a physical button on a phone embodiment, changing the status through clicking a control button 416 or selecting a menu option off the menu bar 404. If the call tunneling is continuing, flow returns to act 624, otherwise, a normal conference call is resumed at act 632.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. An apparatus comprising:
a call processor configured to identify a plurality of call tunneling participants participating in a call tunneling session within a conference call session, and to identify third parties within the conference call session not participating in the call tunneling session;
a call tunneling assistant configured to route communications signals between the call tunneling participants to other call tunneling participants, but not routing the communications signals to the third parties.

2. The apparatus of claim 1, wherein the call tunneling assistant routes communications signals between the call tunneling participants through placing a separate call.

3. The apparatus of claim 1, wherein the call tunneling assistant routes communications signals through the conference call session.

4. The apparatus of claim 1, wherein the call processor ignores communications signals received from the third parties.

5. A method comprising:
receiving a call tunnel request from an initiating party within a conference call session, the call tunnel request identifying at least one receiving party;
routing communications signals between the initiating party and the receiving party as a call tunneling session, and not routing communications signals to other conference call parties when the receiving party agrees to the call tunnel request.

6. The method of claim 5, wherein the routing of communication signals between the initiating party and the receiving party is accomplished through placing a separate call.

7. The method of claim 5, wherein the routing of communication signals between the initiating party and the receiving party is accomplished through the conference call session.

8. The method of claim 5, further comprising:
muting third party communication signals within the call tunneling session.

9. The method of claim 8, wherein the initiating party or the receiving party mutes the third party communication signals through ignoring third party signals.

10. The method of claim 8, wherein third party communication signals are muted because third party stops sending the third party communication signals.

11. The method of claim 5, wherein the receiving party is a participant of the conference call session.

12. The method of claim 5, wherein the receiving party is not a participant of the conference call session.

13. A computer-readable medium encoded with data and instructions, the data and instructions causing an apparatus executing the instructions to:
receive a call tunnel request from an initiating party within a conference call session, the call tunnel request identifying at least one receiving party;
route communications signals between the initiating party and the receiving party as a call tunneling session, and not routing communications signals to other conference call parties when the receiving party agrees to the call tunnel request.

14. The computer-readable medium of claim 13, further encoded with data and instructions, wherein the routing of communication signals between the initiating party and the receiving party is accomplished through placing a separate call.

15. The computer-readable medium of claim 13, wherein the routing of communication signals between the initiating party and the receiving party is accomplished through the conference call session.

16. The computer-readable medium of claim 13, the instructions further comprising:
muting third party communication signals within the call tunneling session.

17. The computer-readable medium of claim 16, wherein the initiating party or the receiving party mutes the third party communication signals through ignoring third party signals.

18. The computer-readable medium of claim 16, wherein third party communication signals are muted because third party stops sending the third party communication signals.

19. The computer-readable medium of claim 16, wherein the receiving party is a participant of the conference call session.

20. The computer-readable medium of claim 16, wherein the receiving party is not a participant of the conference call session.

21. An apparatus comprising:
means for receiving a call tunnel request from an initiating party within a conference call session, the call tunnel request identifying at least one receiving party;
means for routing communications signals between the initiating party and the receiving party as a call tunneling session, and not routing communications signals to other conference call parties when the receiving party agrees to the call tunnel request.

22. The apparatus of claim 21, wherein the routing of communication signals between the initiating party and the receiving party is accomplished through placing a separate call.

23. The apparatus of claim 21, wherein the routing of communication signals between the initiating party and the receiving party is accomplished through the conference call session.

24. The apparatus of claim 21, further comprising:
means for muting third party communication signals within the call tunneling session.

25. A method comprising:
identifying call tunneling participants participating in a call tunneling session within a conference call, and third parties in the conference call not participating in the call tunneling session;
routing communications signals from the call tunneling participants to other call tunneling participants, but not routing the communications signals to third parties.

26. A computer-readable medium encoded with data and instructions, the data and instructions causing an apparatus executing the instructions to:
identifying call tunneling participants participating in a call tunneling session within a conference call, and third parties in the conference call not participating in the call tunneling session;
routing communications signals from the call tunneling participants to other call tunneling participants, but not routing the communications signals to third parties.

27. An apparatus comprising:
means for identifying call tunneling participants participating in a call tunneling session within a conference call, and third parties in the conference call not participating in the call tunneling session;
means for routing communications signals from the call tunneling participants to other call tunneling participants, but not routing the communications signals to third parties.
